(19) United States
(12) Patent Application Publication
(10) Pub. No.: US 2014/0096899 A1
(43) Pub. Date: Apr. 10, 2014

(54) DELUXE BIAS TAPE AND COVERED PIPING MAKING MACHINE

(71) Applicant: Simplicity Pattern Co. Inc., Antioch, TN (US)

(72) Inventors: Kenneth Hatcher, Smyrna, TN (US); Rosemary Shimp, Nashville, TN (US); David Sasur, Ludlow, MA (US)

(73) Assignee: SIMPLICITY PATTERN CO. INC., Antioch, TN (US)

(21) Appl. No.: 13/647,050

(22) Filed: Oct. 8, 2012

(51) Int. Cl. B32B 37/10; B32B 38/00

(52) U.S. Cl. 156/227; 156/443; 156/378; 156/350

(57) ABSTRACT

A combined portable bias tape and covered piping cord making device. A spindle is rotatably disposed in a housing of a device for supporting a strip of material. Also, at least two folding tips are mountable in the housing—e.g., one for making bias tape and one for covering piping cord—each which can be separately mounted within the housing for making product. The device further includes a heated pressing assembly disposed in the housing for receiving and setting folded longitudinal edges of the strip of material. A cover is configured to enclose at least the spindle and part of the heated pressing assembly within the housing in the closed position. Multiple tips and/or parts can be interchanged depending on the size of the materials and/or the produced product (bias tape or covered piping cord).

### BACKGROUND

1. Field

This disclosure is generally related to a device for making bias tape and covered piping cord for finishing and/or decorating garments or the like, and more particularly to a portable device that folds, heats, and presses a strip of fabric to form a single fold bias tape or covered cord.

2. Description of Related Art

Bias tape is made from fabric strips that are cut along the bias grain. Because fabric cut on this grain has a great deal of stretch, the tape fits smoothly around curves without adding unnecessary bulk. Bias tape can be used in place of a facing to finish curved edges, such as armholes, necklines of garments, as well as to finish the edges of many household decorative items, such as quilts and place mats.

There are two types of bias tape: single-fold and double-fold. Single-fold bias tape actually has two folds—one running along each long edge of the tape. When single-fold bias tape is used to finish an item, it is stitched to the item edge with right sides together, and then it is turned to the inside of the item and stitched again. Stitched in this manner, the tape never shows on the outside of the garment. Single fold bias tape that is folded in half again—one seam running down the middle of the tape—becomes double fold bias tape.

Bias tape is commercially available; however, often there are numerous devices available to fold custom single-fold bias tape. U.S. Pat. No. 1,018,227 discloses a bias band maker wherein a fabric strip is passed through the band to produce folds along the longitudinal ends. Thereafter, a conventional iron can be used to press the edges in place.

A more recent bias tape maker enables a strip of fabric to be passed between an inner and outer shell to produce a pair of longitudinally extending folds. A strip of fusible tape can also be incorporated between the folds. Thereafter, the folds can be fixed or set by ironing. See, for example, U.S. Pat. No. 6,641,516.

It is burdensome and dangerous to set the folds of bias tape with an iron or other conventional pressing means. Often the bias tape needs to be of long lengths and the edges can become unfolded or uneven during pressing of the strip. Thus, there is a need for a bias tape maker that folds a strip of material and thermally sets the folds in an even and expeditious manner.

Covered piping cord can also be used to finish decorative items. In a similar manner to bias tape, forming covered piping cord can also be burdensome and dangerous. A machine that can accommodate covering piping cord with fabric is also desirable.

### SUMMARY

It is therefore an aspect of this disclosure to provide a combined bias tape and covered cord maker having a strip folding and thermal fold setting capability.

Another aspect of this disclosure is a combined bias tape and covered cord maker device that has a pressing device that presses the folds without the user having any contact with the heating elements.

Yet another aspect of the combined bias tape and covered cord maker is to accommodate the creation of multiple sizes of a single-fold bias tape and/or covered piping cord.

Still another aspect of the combined bias tape and covered cord maker of the disclosure is to enable different types of material to be pressed by providing temperature and speed adjustability and control of the heating assembly.

According to these and other aspects of the disclosure there is provided a combined portable bias tape and covered piping cord making device. The device includes: a housing having a main housing and a cover hingedly connected to the main housing, the cover being configured to be positioned in an open position with respect to the main housing and in a closed position with respect to the main housing as well as a spindle rotatably disposed in the housing for supporting a strip of material. Also, at least two folding tips are mountable in the housing each separately configured for mounting within the housing for communication with the spindle for folding longitudinal edges of the strip of material, at least a first folding tip for folding the strip of material into a bias tape and at least a second folding tip for folding the strip of material around a piping cord to cover the piping cord. The device further includes a heated pressing assembly disposed in the housing for receiving and setting the folded longitudinal edges of the strip of material. The spindle is mounted within one of the cover or the main housing, and one of the at least two folding tips and the heated pressing assembly are mounted within the other of the cover or the main housing, such that, with the housing in the open position, the spindle, the mounted folding tip, and the heated pressing assembly are configured for operation. The cover is configured to enclose at least the spindle and at least part of the heated pressing assembly within the housing in the closed position.

This disclosure further provides for a method of making a covered piping cord. The method includes: providing a device, the device including a housing, a spindle rotatably disposed in the housing for supporting a strip of material, at least one folding tip for folding the strip of material around a piping cord to cover the piping cord and mountable in the housing in communication with the spindle, and a heated pressing assembly disposed in the housing for receiving the strip and piping cord; wrapping a length of fabric strip on the spindle; mounting the at least one folding tip within the housing; passing at least the fabric strip and piping cord through the mounted folding tip; folding longitudinal edges of the fabric strip around the piping cord to cover the cord; and feeding the covered piping cord through the heated pressing assembly and pressing the folded longitudinal edges of the fabric strip.

Other aspects, features, and advantages of the present disclosure will become apparent from the following detailed description, the accompanying drawings, and the appended claims.

### BRIEF DESCRIPTION OF THE DRAWINGS

FIG. 1 is a perspective view of the device assembled and configured for bias tape making in accordance with an embodiment of the present disclosure.

FIG. 2 is an alternate perspective view of the device assembled and configured for making bias tape as shown in FIG. 1.

FIG. 3 is a perspective view of a fabric spindle in accordance with an embodiment of the present disclosure.

FIG. 4 is a perspective view of a guide arm in accordance with an embodiment of the present disclosure.

FIG. 5 is a perspective view of an insert in accordance with an embodiment of the present disclosure.

FIG. 6 is a rear perspective view of a fabric folding tip used for making bias tape in accordance with an embodiment of the present disclosure.

FIG. 7 is a top perspective view of an inner core of the folding tip of FIG. 6.

FIG. 8 is a top perspective view of a clamp of the folding tip of FIG. 6.

FIG. 9 is a cross-sectional view of the fabric folding tip taken along line II-II of FIG. 6.

FIG. 10 is a perspective view of the main housing of the present disclosure with its middle cover removed.

FIG. 11 is a perspective underside view of part of a heated pressing assembly provided in main housing of FIG. 10.

FIG. 12 is a perspective side view of an upper part of the heating assembly of FIG. 11 without its cover.

FIG. 13 is a perspective view of components mounted within the main housing of FIG. 10.

FIG. 14 is a perspective underside view of upper and lower heating plates of the heated pressing assembly.

FIG. 15 is a perspective view of the device in use for bias taping making with a fabric strip that is guided from spindle and into the heated pressing assembly.

FIG. 16 is an overhead perspective view of the fabric strip as it passes through the pressing assembly.

FIG. 17 is a perspective view of the device assembled and configured for covered piping cord making in accordance with an embodiment of the present disclosure.

FIG. 18 is an overhead view of the upper cover of the device assembled and configured for making covered cord as shown in FIG. 17.

FIG. 19 is an overhead view of the main housing of the device as shown in FIG. 17 without a cover on the heated press assembly.

FIGS. 20-25 show perspective views of an insertion side of a plurality of tips configured for use with the device for making covered piping cord in accordance with an embodiment of the present disclosure.

FIGS. 26-31 show overhead views of an upper part or cover of the heating assembly in accordance with embodiments herein configured for use with a corresponding tip shown in FIGS. 20-25.

FIG. 32 shows a perspective underside view of an upper part or cover of the heating assembly that is configured for use with the device in accordance with an embodiment of the disclosure.

FIG. 33 is a perspective view of the device in use for covered piping cord making with a fabric strip that is guided from an assembled spindle and into the heated pressing assembly with fusing material and cord.

FIG. 34 is a side view of the fabric strip as it passes through the tip and pressing assembly with fusing material and cord.

FIG. 35 is a detailed view of the fabric strip, cord, and fusing material within a guide tip in accordance with an embodiment of this disclosure.

FIGS. 36-41 show examples of different sized finished piping cord made with the device disclosed herein.

### DETAILED DESCRIPTION OF THE PREFERRED EMBODIMENT(S)

As described in the exemplary embodiments below, the disclosed machine serves two functions: to make single fold bias tape using fabric as well as to cover piping cord with fabric. The combined bias tape and piping machine or device 10 as disclosed herein provides two machines-in-one for making products that can be used in decorating projects. The attachments associated with both utilities can be stored within the device (its housing and cover), which provides portability of the machine.

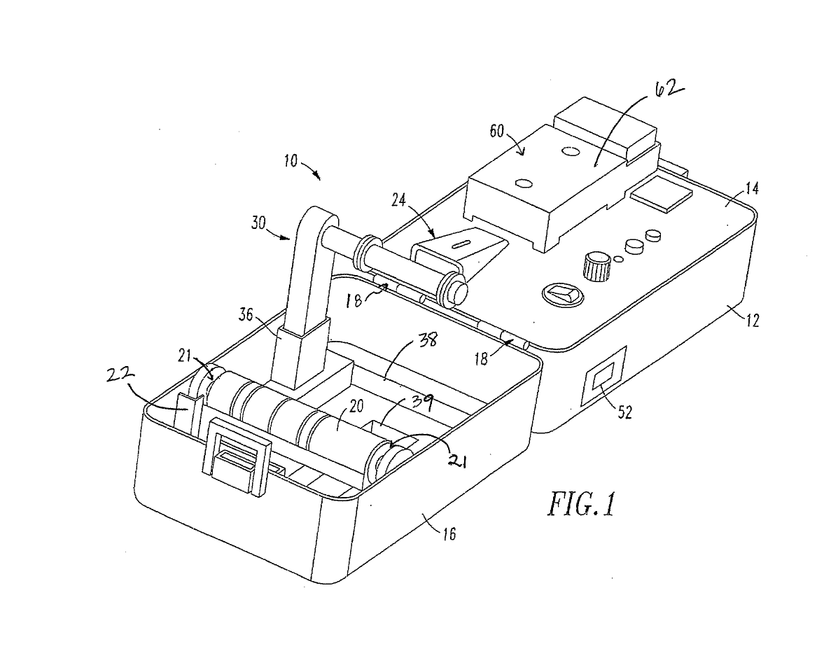

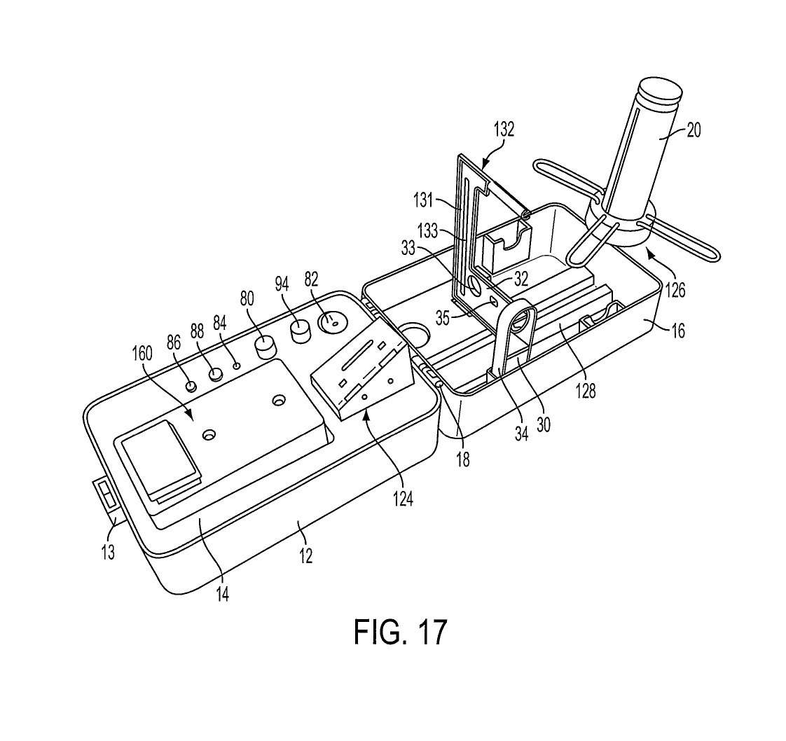

Referring now more particularly to the drawings, at least FIGS. 1-2 and 15-16 show details of the assembled features of the disclosed device 10 in use for making bias tape. Such features are also similarly disclosed in U.S. patent application Ser. No. 12/464,490, filed May 12, 2009 (Published as 2010/0292064 A1), which is hereby incorporated by reference in its entirety. At least FIGS. 17-19 and 33-35 show details of the assembled features of the disclosed device 10 in use for making covered piping cord.

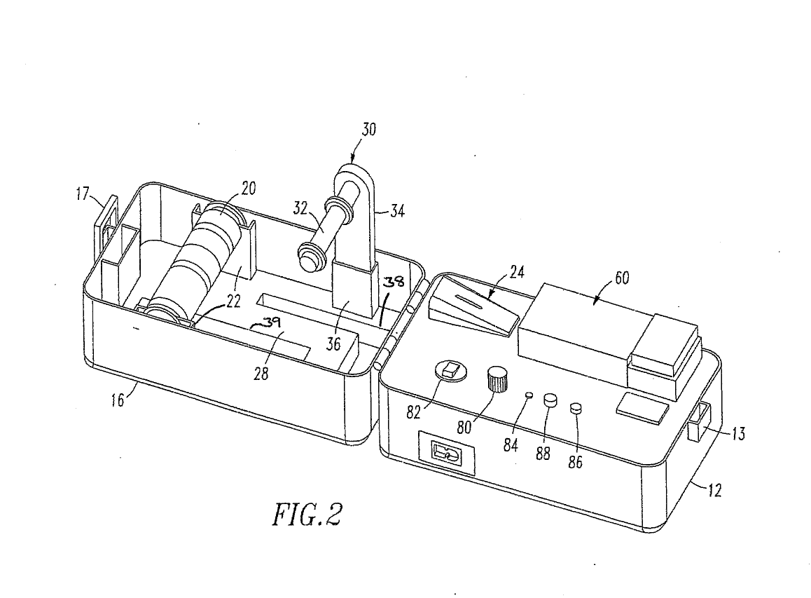

Referring to FIGS. 1 and 2, the device 10 of the present disclosure includes a main housing 12, a middle cover 14, and an upper cover 16. Upper cover 16 is movably connected to main housing 12 via one or more hinges 18 between an open position with respect to the main housing 12 and a closed position with respect to the main housing 12. The housing and covers can be made of a flame retardant ABS compound, or other plastics, for example, and formed via a molding process, for example. The device 10, as shown in FIGS. 1 and 2, has its parts mounted and assembled for making bias tape.

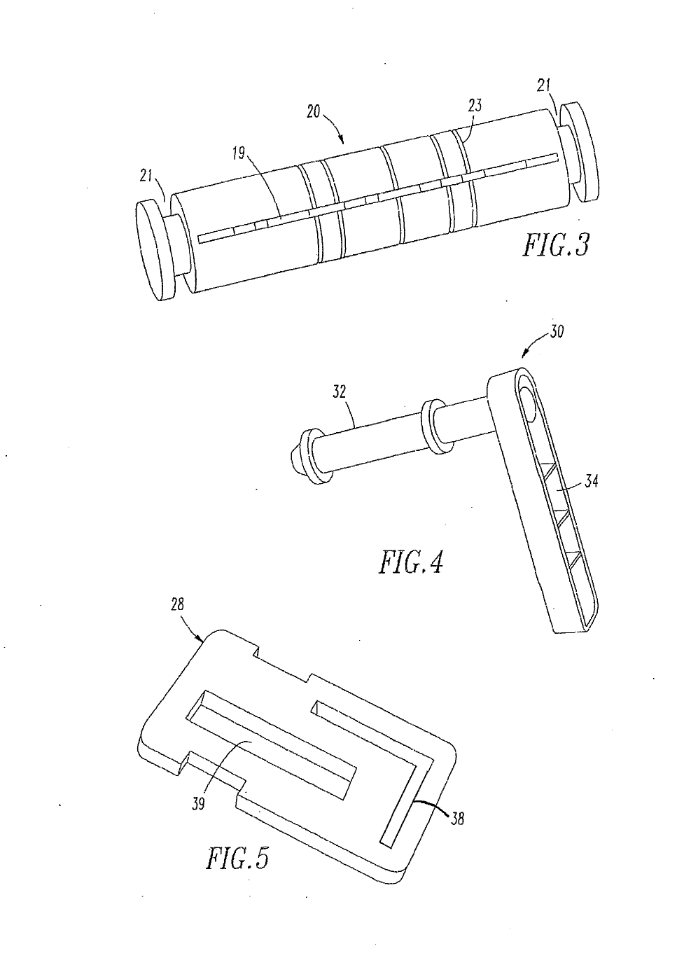

A spindle 20 is located in upper cover 16 and is configured to be rotatably disposed in the housing for supporting a strip of material or fabric. Throughout this disclosure, “material” and “fabric” are used interchangeably, and may include lightweight cottons to heavier decorating fabrics (e.g., wool). Strips of fabric may be cut to size based on the size of the tip and product being formed. Spindle 20 is moved between a storage position (within slot 39 of upper cover 16) and a use position. In use, a strip of fabric or material (not shown) is wound on and around a body of the spindle 20 and the spindle is placed in forks 22 (see also FIG. 2). Spindle 20 is configured to rotate about an axis to feed fabric or material wrapped therearound when forming bias tape (or, in some cases, piping material). As can be seen in greater detail in FIG. 3, grooves 21 are provided near the ends of the spindle 20 that are rotatably received in forks 22. Spindle 20 also includes a slot 19 extending axially therein. A trailing end of the fabric strip can be inserted into slot 19 to aid in wrapping the strip evenly on and around spindle 20.

A guide 30 is also located in cover 16. As shown in FIG. 4, guide 30 includes an arm 32 and a support 34. As will be described further herein, the fabric from spindle 20 is draped over guide arm 32 and inserted into a bias tape folding tip 24 provided on main housing 12. Spindle 20 includes a plurality of striations 23 spaced longitudinally from each other and around the diameter of the body of the spindle for properly positioning different sizes of fabric strips to align the same guide 30. An end of support 34 is removably located in a post 36 of cover 16. Guide 30 can be made of a flame retardant ABS compound, or other plastics, for example, and formed via a molding process, for example.

Device 10 is portable and when not in use spindle 20 and guide 30 can be removed and placed within shaped slots of an insert 28 (see FIG. 2) provided within cover 16. As shown in detail in FIG. 5, an L-shaped slot 38 is provided in insert 28 to accommodate guide 30. A second slot 39 is capable of receiving spindle 20. When spindle 20 and guide 30 are stored within insert 28, the device 10 can be closed by rotating cover 16 about one or more hinges 18 towards housing 12. Referring again to FIG. 2, cover 16 includes a latch 17 that corresponds with a notch 13 located on main housing 12 to lock cover 16 in place with the housing 12.

Also, although not shown, a handle can be provided on device 10. A handle can be constructed and arranged to enable a user to carry the portable device 10. For example, a top surface or wall of cover 16 may include a depression constructed and arranged to receive the handle when not in use. In an embodiment, the handle may be pivotably attached to a top wall of device 10. There may be a recessed area adjacent to a depression to enable easy grasping of handle, for example. Also, handle may optionally be attached to device 10 via attachment devices such as pins, hinges, snap-fit connections, or other connecting mechanisms.

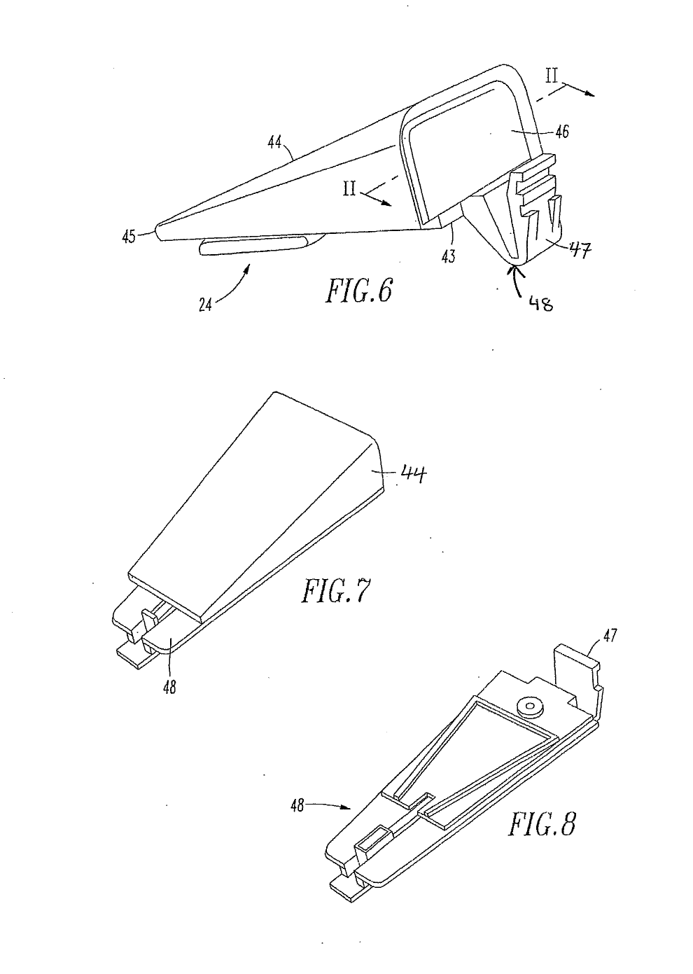

Main housing 12 comprises additional components that are used to form the bias tape (or covered piping cord), including at least one bias tape folding tip 24 and heated pressing assembly 60. An example of a bias tape folding tip 24 is shown in detail in FIGS. 6-9. Tip 24 folds the strip of fabric into a single fold bias tape. Tip 24 includes an outer shell 44 and an inner core 46 that is inserted into outer shell 44. Both outer shell 44 and inner core 46 (see FIGS. 6-8) are tapered from their respective back or rear 43 (i.e., receiving) end to front (i.e., feeding) end 45.

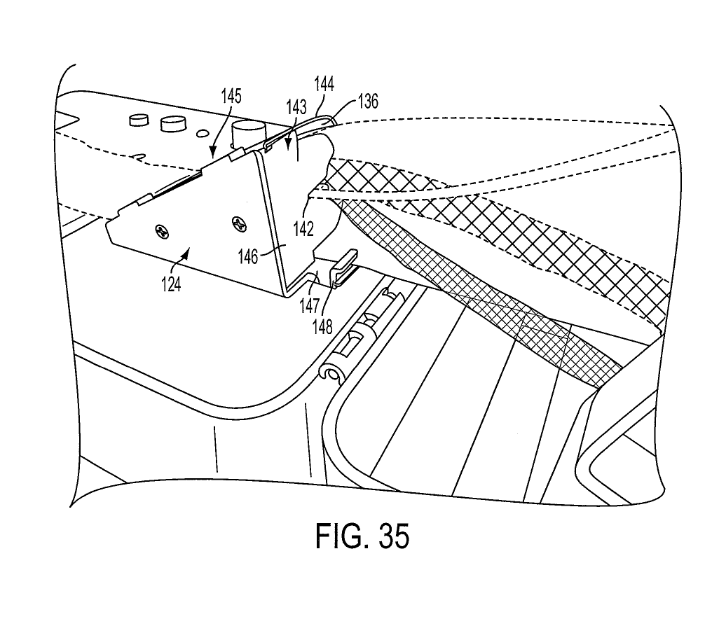

Clamp 48 is connected to inner core 46 as shown in FIG. 6. Clamp 48 has a tab 47 that extends below the tip and is received within a slot (an example of which is shown in FIG. 35) and snapped in place in middle cover 14. Tab 47 is a spring mechanism that allows the entire tip 24 to be disengaged from the device 10 when pressed by a user. In that manner, device 10 can be used with multiple sized tips to accommodate multiple sizes of fabric and fold multiple sizes of single fold bias tape. A user can change the tip 24 based on the finished size of bias tape needed. For example, sizes of tips that can be used with the device of this disclosure can be ⅛, ¼, ⅜, ½, ¾, 1, and 1¼ inches. In a non-limiting embodiment, the sizes of the tips correspond to or refer to the size of the single bias tape that is made, i.e., bias tape can be formed with a width of ⅛, ¼, ⅜, ½, ¾, ⅞, 1, 1⅛, or 1¼ inches, depending on the selected tip. Tips that fold a 1⅞ inch and/or a 2 inch strip of material in half (so that a width of the finished and folded tape is half of the fed material, e.g., 0.9375 inches or 1 inch wide tape) can be used with the device. Additionally, a tip can be provided that folds a 2¼ inch in half to only a 1⅛ inch wide bias tape, and/or a tip can be provided that folds a 2½ inch strip in half to only a 1¼ inch wide bias tape. It should be appreciated that this disclosure is not limited to these size tips, but can accommodate other sizes as well.

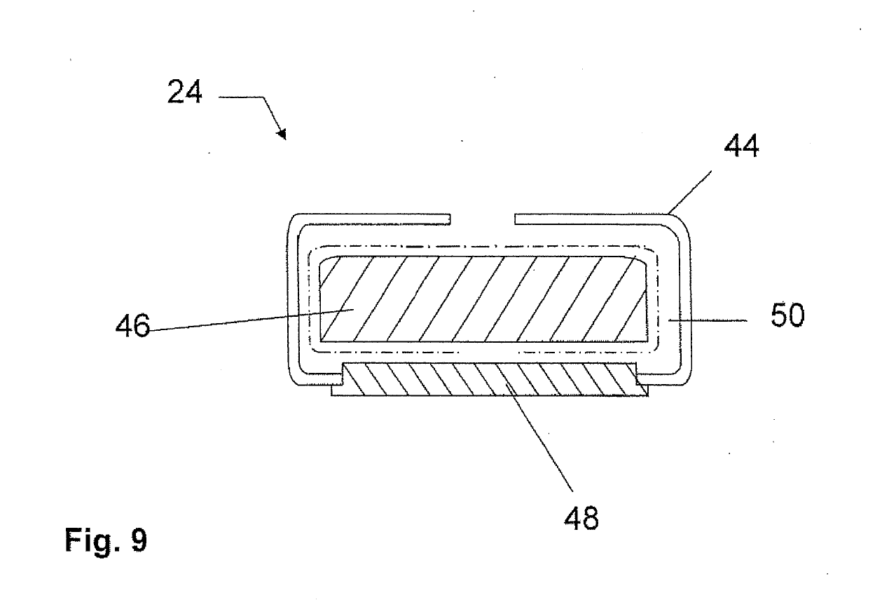

Referring to FIG. 9, in use, a lead edge of a fabric 50 (drawn from spindle 20), shown in dashed line, is placed on top of guide 30 and inserted into tip 24 from the rear end 43 (see FIG. 6) thereof between outer shell 44, inner core 46, and clamp 48. As fabric strip 50 is advanced the strip is folded along its edges to form the single fold bias tape and the folded strip is pulled from the front end 45 (see FIG. 6) of the tip.

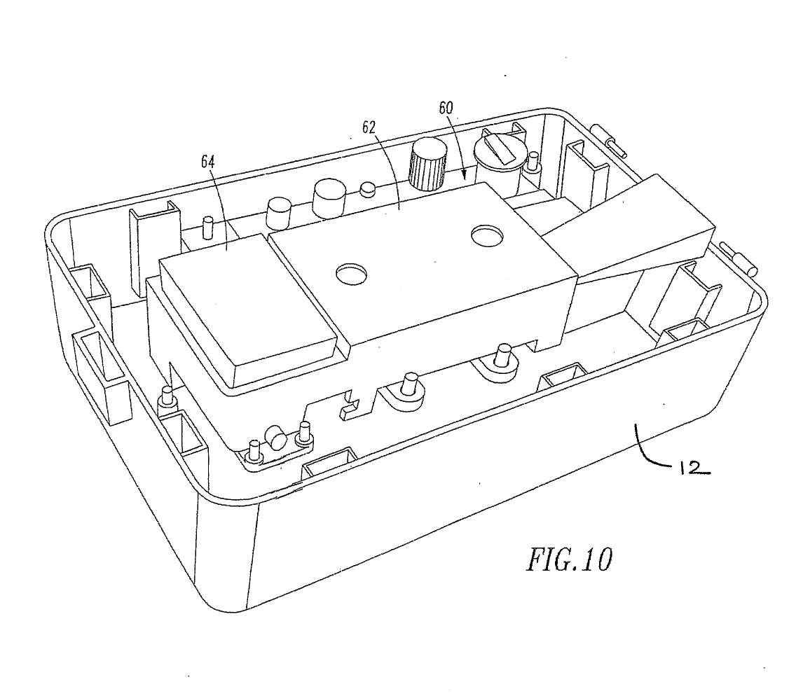

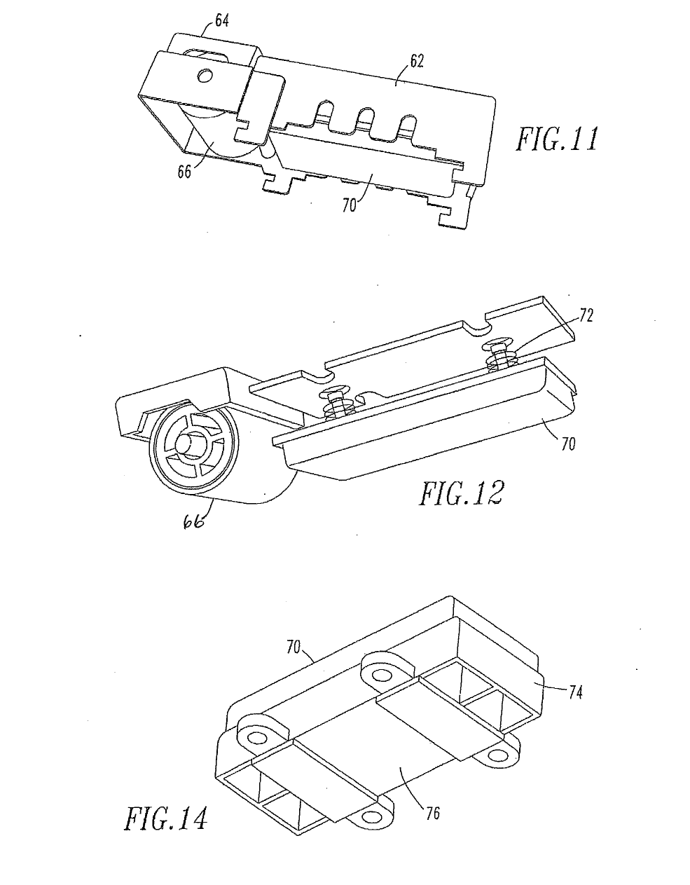

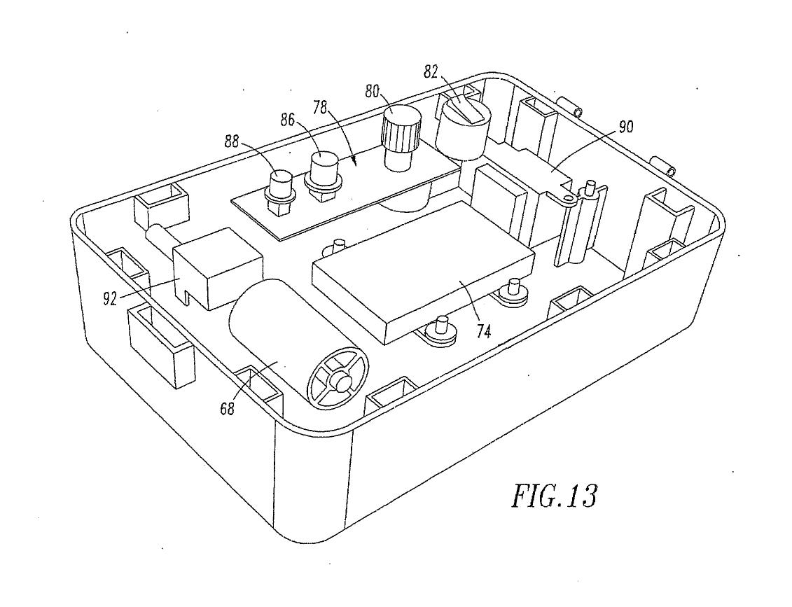

Referring again to FIGS. 1 and 2, device 10 includes a heated pressing assembly 60 located in main housing 12 downstream of tip 24. As shown in FIG. 10 (middle cover 14 being removed from main housing 12 in this view), pressing assembly 60 includes a removable upper housing 62 and an upper roller case 64 (also called an “iron cover” throughout this disclosure). Located in upper roller case 64 is an upper roller 66 as shown in FIG. 11. Upper roller 66 corresponds with lower roller 68 mounted in a bottom of main housing 12 (see FIG. 13) to pull the folded bias tape through the pressing assembly 60, as will be described further herein. Rollers 66, 68 can be made of steel and/or silicone, for example.

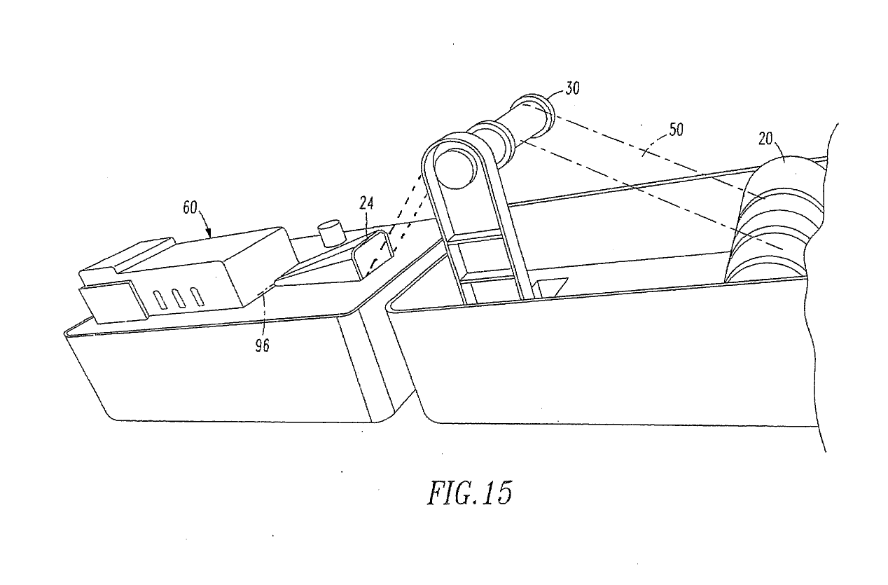

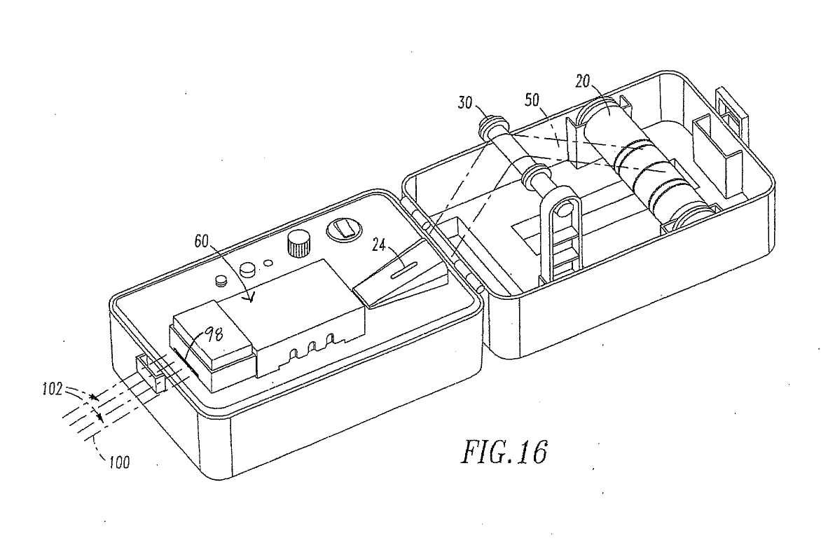

Upper housing 62 includes an upper spring-loaded plate 70 as shown in FIGS. 11 and 12. Plate 70 is biased downwardly by springs 72 to supply the appropriate pressure to the folded bias tape as it passes thereunder through an opening or feed slot 96 (see FIG. 15) and out of a dispensing slot 98 (see FIG. 16). Plate 70 can be made of a ceramic, for example, for heat dispersion.

Referring to FIG. 13, a stationary plate 74 is located in main housing 12 directly beneath spring-loaded plate 72. Plate 74 can be made of a Teflon® coated iron or other material. Plate 74 is coated to have a non-stick surface and thus to allow the folded bias strip to pass smoothly between it and upper spring-loaded plate 70. As shown in FIG. 14, a heating block 76 is located beneath stationary plate 74.

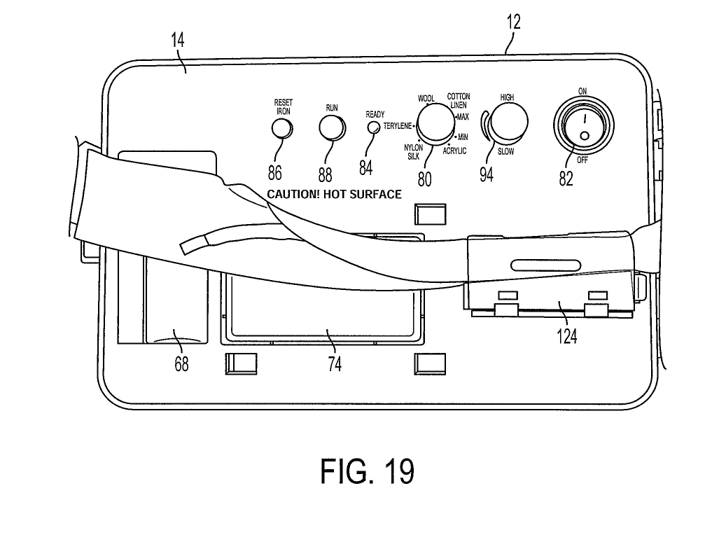

As shown in FIG. 13, a heating control unit 78 communicates with heating block 76 to control and monitor the heating of block 76 and stationary plate 74. The buttons, dials, and devices associated with the heating control unit 78 may be accessible or viewable when middle cover is in place (e.g., see FIG. 1). A temperature dial 80 associated with the heating control unit 78 can be set for different types of fabric to regulate heat control accordingly. In an embodiment, such as shown in detail in FIG. 19, labels may be provided on middle cover 14 to indicate one or more predetermined temperatures to which temperature dial 80 can be turned and set (e.g., for use with particular types of materials or fabrics). When the device has reached a desired temperature, a light 84 (see FIG. 2) on the main housing 12 will glow to indicate that the device is ready. Additionally and/or alternatively, other indicator devices, such as an alarm or a sound emitting device, may also be associated with heating control unit 78 and provided on device 10. Control unit 78 also includes an automatic shut-off feature that substantially reduces and/or substantially eliminates power to the device should the device be inactive for more than 10 minutes and/or should the device overheat. For safety reasons, the fabric should be threaded through the tip and rollers prior to the temperature dial being turned on. This is to reduce and/or prevent burning of hands or fingers of a user on the heated iron surface as the fabric is passed over the heated iron surface (and a user's hands are near it).

In addition to temperature dial 80, a power switch 82 (e.g., ON/OFF toggle switch), a reset button 86 and a run button 88 are provided in main housing 12. Power switch 82 communicates with a transformer 90 and motor and gear box unit 92 for driving lower roller 68. In accordance with an embodiment, the temperature control and machine operation work independently. For example, after light 84 indicates that the heating block 76 is ready, run button 88 can be manually pressed by the user to start the rotation of the rollers 66, 68. More specifically, the pressing of run button 88 causes the unit to communicate with motor and gearbox unit 92 in order to rotate lower roller 68, which in turn can rotate upper roller 66. The user can also press button 88 to stop movement of the rollers (while heating block 76 can continue to heat at least stationary plate 74).

In one embodiment, device 10 comprises a speed control dial 94, which is shown in detail in the embodiment of FIG. 19. Speed control dial 94 allows for adjustment of the speed at which fabric is fed and run across the heating element. More specifically, it allows for the adjustment of the speed at which lower roller 68 is rotated by motor and gearbox unit. This can be useful when using different types of fabrics for tape or cord makings For example, when using heavier fabrics (such as wool) the feed speed of the fabric through the heated pressing assembly 60 can be adjusted (e.g., slower) as it is drawn from spindle 20 through a tip so that it spends a desirable amount of time (e.g., more time) adjacent to the heated stationary plate 74 and rollers 66, 68 during feeding and pressing.

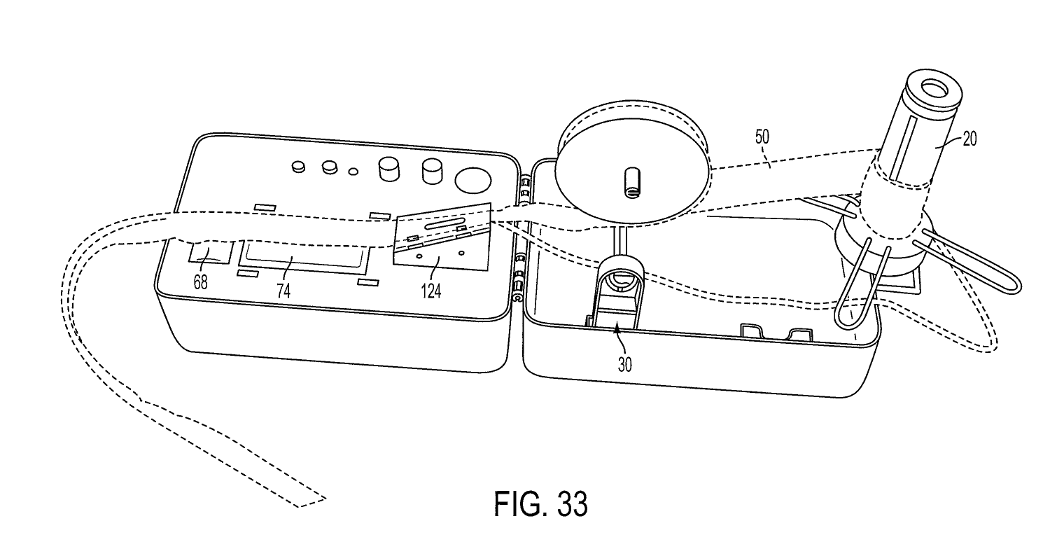

Middle cover 14 comprises holes, openings, or slots therein designed to accommodate devices housed within main housing 12. For example, one or more slots (shown in FIG. 35) are provided in middle cover 14 such tip 24 can be snapped and locked in place (e.g., via clamp 48) within middle cover 14. Openings are also provided in middle cover such that control buttons 80, 82, 86, and 88 extend therethrough and are accessible to a user. Additionally, middle cover 14 has openings that allow lower roller 68 and stationary plate 74 to extend at least slightly within their openings and/or therethrough so that the fabric makes contact with both of the lower roller 68 and plate 74 as the bias tape (or piping) is formed and fed therealong (i.e., during use, iron cover or housing 62 is in place) (see, e.g., FIGS. 19 and 33, which shows such openings in middle cover 14 since in these Figures the iron cover of heated pressing assembly is removed).

Referring to FIGS. 13, 15 and 16, in operation (i.e., after the heating block 76 heats at least the stationary plate 74 and light 84 indicates the device is ready), the strip of material 50, shown in dashed lines, is wrapped around spindle 20 with the finish side up and center to tip 24. The spindle 20 is placed in forks 22 of upper cover 16 for rotation. The leading edge of strip 50, is inserted into tip 24, preferably before the plate 74 is heated. A mechanism (not shown) can be provided to advance the edge of the strip through tip 24 such that the strip is folded along both sides to form a single fold bias tape. For example, such a device may be a manual insertion tool (separate from the machine) that aids in pushing the strip through the tip. In an embodiment, the movement of the strip through the tip can be pushed or aided using a pin, scissors, or other device that fits into the open slot of the tip. Upper housing 62 of the heating assembly is removed (before or after feeding into tip 24) and the leading edge of the folded tape is pulled across plate 74 and roller 68. Upper housing 62 is replaced and snapped into position on middle cover 14, so that the fabric extends through feed slot 96 and at least partially out of dispensing slot 98. When powered (via pressing run button 88), the rollers 68 and 66 are rotated to advance the folded strip from the tip 24, and heated press assembly 60 presses folds 102 along either side of folded fabric received from tip 24 between plates 70 and 74 to form the finished single fold bias tape 100 that is ejected from dispensing slot 98. The spindle 20 rotates about its axis as the strip of material is advanced or pulled through the tip 24 and heated press assembly 60. The device can fold and press the single fold bias tape with a continuous feed at approximately 15 ft/min.

The device is designed for universal electronic sources and is UL approved for the United States and Australia. An outlet 52 (FIG. 1) is provided in main housing 12 for access to or connection of a power cord and electronic source.

In accordance with another embodiment, the device 10 is used for making covered piping cord. For example, some accessories can be exchanged within the housing 12 and upper cover 16 to accommodate the materials used to form the covered cord, which are further described below. However, since the same device 10 is used in this embodiment, FIGS. 17-35 include many of the same reference numbers to indicate its parts therein. Accordingly, it should be understood that the description provided above with reference to the machine's use for bias tape making similarly applies to the features and parts shown in FIG. 17-35, and, therefore, are not necessarily repeated for each of the below described embodiments when the machine is assembled and configured for making covered piping cord.

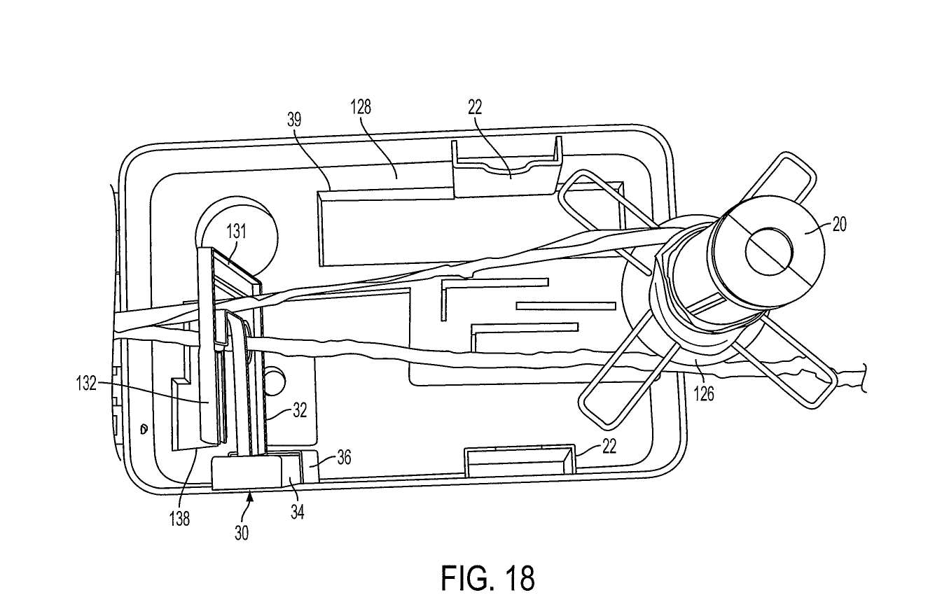

Referring to FIGS. 17-19, there are shown parts of the device in this embodiment that, as illustrated, can be mounted and assembled to use the device 10 of the present disclosure to form covered piping cord. Rather than being rotatably disposed in the cover 16, spindle 20 is mounted to a rotatable base 126 for supporting a strip of material or fabric. Rotatable base 126 is placed within a predetermined opening or notch such that spindle 20 is positioned in a vertical direction and configured to rotate about vertical axis (as opposed to a horizontal direction rotating about a horizontal axis within the housing, as shown in FIGS. 1 and 2). For example, in an embodiment, the opening may be associated with notch 13 configured to releasably lock with latch 17 (when unlatched and the housing is in the open position), e.g., see FIG. 2. Rotatable base 126 has legs that extend from its base to keep fabric from slipping off of its spindle body. The legs are removable from the base 126. The spindle 20, rotatable base 126, and legs are all storable in the cover 16 (e.g., in the insert). In use, spindle 20 is moved (e.g., from its storage position within slot 39a) and a strip of fabric or material (see FIG. 18) is wound on and around a body of the spindle 20. Legs are attached to rotatable base 126. The spindle 20 is inserted into or placed onto rotatable base 126, and the assembly is then inserted into the predetermined opening.

Similar to the embodiment described with respect to FIG. 3, a guide 30 is provided that includes an arm 32 and a support 34. However, in accordance with another embodiment as shown in FIGS. 17 and 18, arm 32 has a vertical extension 131 extending from its end. Vertical extension 131 has a slot 133 configured to receive and guide fabric from spindle 20 therethrough. Also, arm 32 has an opening 33 for receiving and guiding piping cord as it is fed therethrough. Additionally, arm 32 has a receiving opening 35 for receiving and guiding fusible material (film or web). For example, in accordance with an embodiment, fusing material is passed with the piping cord and fabric strip through heated pressing assembly 160 to fuse the longitudinal edges of the strip of fabric around piping cord by heating the fusing material. Thus, in accordance with an embodiment, a second spindle 132 is attached to a distal end of vertical extension 131. Spindle 132 is positioned along a horizontal axis that is parallel to arm 32. Spindle 132 is configured to receive a spool of fusing material, such as shown in FIG. 33. Fusing material is drawn from the spool on spindle 132 to rotate about a horizontal axis and is fed through receiving opening 35 for wrapping with piping cord and fabric.

Alternatively, in accordance with another embodiment, a spindle of piping cord may be provided on spindle 132. For example, if the fabric for covering the piping cord itself is fusible, fusible material need not be provided. Accordingly, spindle 132 can be used to feed piping cord in the device 10.

As will be described further herein, in one embodiment, the fabric from spindle 20 is fed through slot 133 of vertical extension 131 in guide arm 32. Piping cord is fed through opening 33 and fusible web from spindle 132 is fed through receiving opening 35. The fabric, cord, and fusible web are inserted into a folding tip 124 provided on main housing 12 to form the covered piping cord.

When not in use, spindle 20 and guide 30 can be removed and placed within shaped slots of an insert 128 provided within cover 16. As shown in detail in FIG. 18, for example, a correspondingly shaped slot 138 is provided in insert 28 to accommodate guide 30. A second slot 39 is capable of receiving spindle 20. When spindle 20, base 126, and guide 30 are stored within insert 128, the device 10 can be closed by rotating cover 16 about one or more hinges 18 towards housing 12. Latch 17 and notch 13 can be used to lock cover 16 in place with the main housing 12.

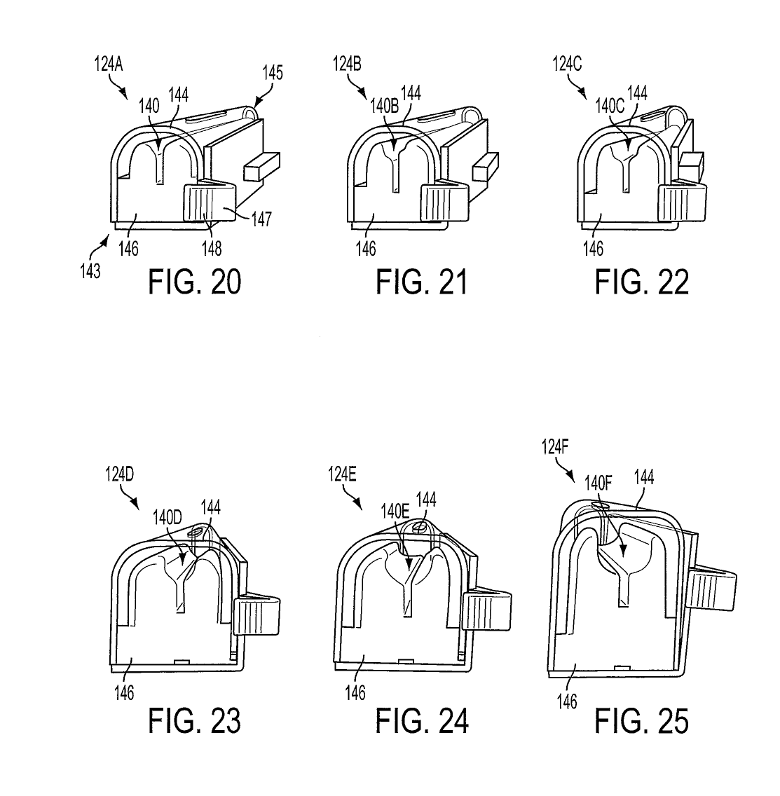

Main housing 12 comprises additional components that are used when forming covered piping cord, including at least one folding tip 124 for folding fabric around a cord and a heated pressing assembly 160. Examples of folding tips 124 are shown in detail in FIGS. 20-25 (shown on their sides). Each tip 124 folds the strip of fabric around piping cord. Each tip 124 includes an outer shell 144 and an inner core 146 that is inserted into outer shell 144. Both outer shell 144 and inner core 146 (see FIG. 17) are tapered from their respective back or rear 143 (i.e., receiving) end to front (i.e., feeding) end 145. A substantially U-shaped fabric receiving space 136 is provided between the outer shell 144 and inner core 146. Referring to FIG. 20, for example, inner core 146 of each tip 124 comprises a channel 140 formed therein that extends along the tapered body thereof and is configured to receive and guide piping cord. Additionally, connected to each channel 140 is a groove 142 or slot that is configured to receive and guide a fusible material.

Clamps 148 are connected to each inner core 146 adjacent a bottom surface thereof. Clamp 148 has a tab 147 that extends below a bottom surface of the respective tip 124 and is received within a slot (shown in FIG. 35) and snapped in place in middle cover 14. Tab 147 is a spring mechanism that allows the entire tip 124 to be disengaged from the device 10 when pressed by a user. In that manner, device 10 can be used with multiple sized tips to accommodate multiple sizes of piping and fabric to form covered piping material. Each diameter piping can use its own guide. A user can change the tip 124 based on the size of cord and/or the finished size of bias tape needed. For example, sizes of tips that can be used with the device of this disclosure can be 4/32, 6/32, 8/32, 10/32, 12/32, and 16/32. In accordance with an embodiment, the sizes of the tips, for example, refer to the size of the cording that is used in the corresponding sized tip and cover. As known in the art, it is standard in the industry to refer to cording sizes in 32 nds. It should be appreciated that this disclosure is not limited to these size tips, but can accommodate other sizes as well.

Depending on the size of the fabric and piping cord, a correspondingly sized tip 124 can be selected. Each tip 124 has features that are sized accordingly. For example, as shown in FIG. 20, tip 124A comprises a channel 140 that is configured to receive piping cord of 4/32 inches. A 1⅜ inch strip of fabric is fed through U-shaped fabric receiving space 136. FIGS. 21-25 show multiple sized tips configured to receive piping cord of similar size; namely, 4/32″, 6/32″, 8/32″, 10/32″, 12/32″, and 16/32″, respectively. The tips of FIGS. 21-25 are configured to receive cut material or fabric strips of approximately 1⅜″, 1⅝″, 1¾″, 2½″, 2⅝″, and 3⅛″, respectively.

Accordingly, besides selecting between a bias tape tip and a tip for covering cord, it should be understood that a user can choose between different sized bias tape tips as well as different sized cord tips for mounting in middle cover 14 for use in device 10. The selected tip is mounted and connected into its slot on middle via its clamp 148 and is ready for use.

In use, a lead edge of fusing material (if used, drawn from spindle 132), shown in dashed line, is inserted and fed through groove 142 of the mounted tip 124. FIG. 35 shows a detailed view of such features. A lead edge of piping cord, shown in dashed line, is assembled and fed through channel 140, and a lead edge of a fabric 50 (drawn from spindle 20), also shown in dashed line, assembled through slot 133 of guide 30 and inserted into the mounted tip 124 from its rear end 143 thereof between outer shell 144 and inner core 146. As fabric strip 50 is advanced, the longitudinal edges of the strip are folded and wrapped to surround the piping cord to form the covered piping cord and the folded strip is pulled from the front end 145 of the tip 124.

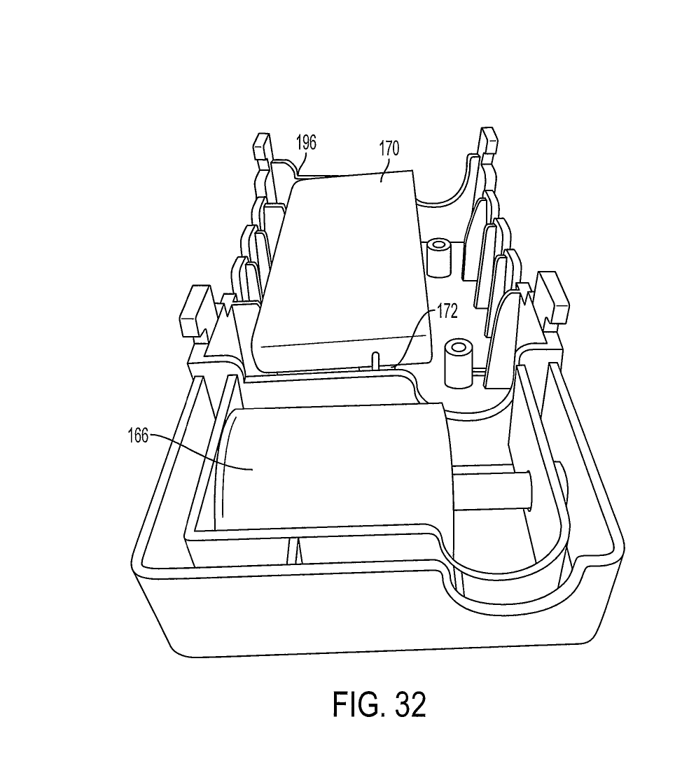

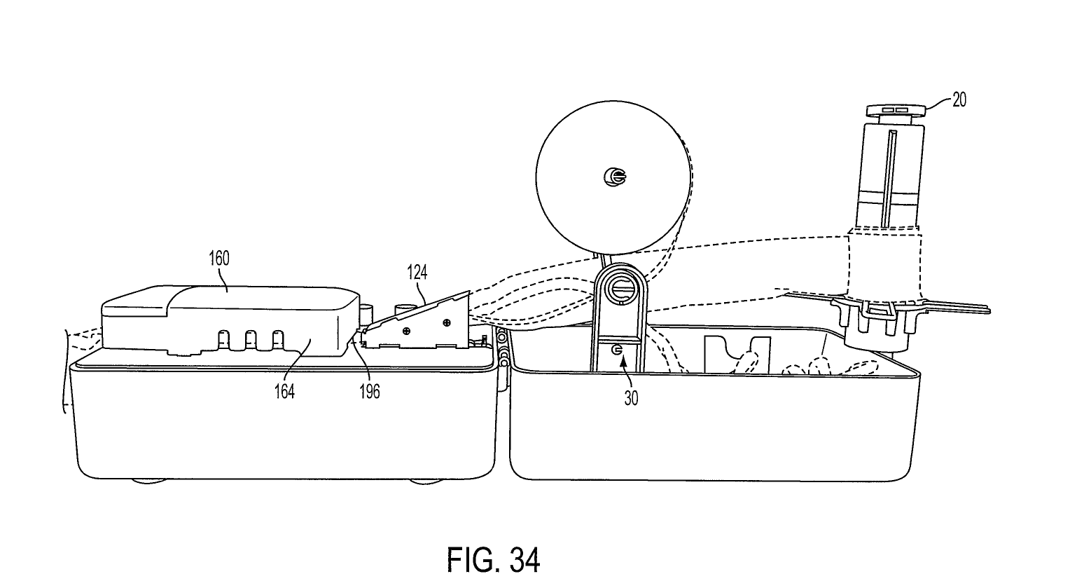

Referring again to FIG. 17, device 10 includes a heated pressing assembly 160 located in main housing 12 downstream of mounted tip 124. As shown via FIG. 19 and FIG. 34, for example, pressing assembly 160 includes at least one removable upper roller case 164 or iron cover. Located in upper roller case 164 is an upper roller 166, as shown in FIG. 32. Upper roller 166 corresponds with the lower roller 68 mounted in a bottom of main housing 12 (e.g., see FIGS. 19 and 33) to pull the covered piping cord through the pressing assembly 160 in a similar manner as previously described above with respect to bias tape. Roller 166 can be made of steel and/or silicone, for example.

Upper roller case 164 also includes an upper spring-loaded plate 170. An example is shown in FIGS. 31 and 32. When mounted to device 10, plate 170 is biased downwardly by springs 172 (like springs 72) to supply the appropriate pressure to the wrapped piping cord as it passes thereunder through an opening or feed slot 196 (see FIG. 34) and out of a dispensing slot (not shown). Plate 170 can be made of a ceramic, for example, for heat dispersion. Feed slot 196 and dispensing slot are shaped such that a diameter of the selected piping cord can be fed easily through. For example, each slot can have round grooves that correspond to a particular size piping cord (in a similar manner to channel 146).

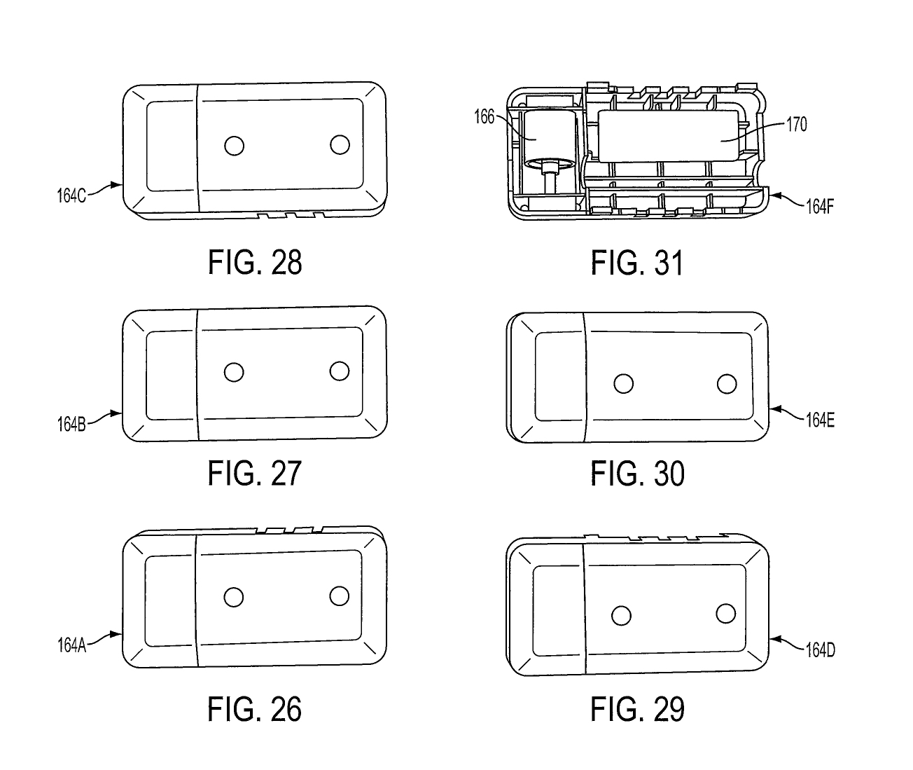

Moreover, in an embodiment, device 10 can be used with multiple upper roller cases 164. That is, in one embodiment, each tip 124 may be paired with a corresponding upper roller case 164. A user can select and mount the roller case 164 with its related tip 124 based on the finished size of covered cord needed. For example, for each sized tip that can be used with the device of this disclosure, a corresponding upper roller case is provided and/or paired therewith. As shown in FIGS. 26-31, a plurality of cases 164A-164F that correspond to each of the tips 124A-124F shown in FIGS. 20-25 can be provided. This is so that the size (diameter) of the piping cord fed through the channel 140 of a mounted tip 124 can fit through the fed and dispensing slots (or, more specifically, their grooves) of the upper roller case. It should be appreciated that this disclosure is not limited to these size tips, but can accommodate other sizes as well.

As previously noted, stationary plate 74 is located in main housing 12 directly beneath spring-loaded plate 72 or 172 when the upper roller case 64 or 164 is mounted on the device 10. As described above with respect to FIG. 14, the heating block 76 located beneath stationary plate 74 is heated via heating control unit 78 and controlled via one or more buttons, dials, or devices 80-94 associated therewith.

Referring to FIGS. 33-35, in operation (i.e., after the heating block 76 heats at least the stationary plate 74 and light 84 indicates the device is ready), the strip of material 50, shown in dashed lines, is wrapped around spindle 20 with the finished side facing outwardly (to surround piping cord on its inside). The spindle 20 is placed in upper cover 16 for rotation via rotatable base 126. Guide 30 is mounted in forks 22 and a spindle of fusing material is mounted on spindle 132. The edge of fusing material is fed through guide 30 along with piping cord (which is described above). The leading edges of fusing material are inserted into groove 142, of cord into channel 140, and of strip 50 into U-shaped fabric receiving space 136 of mounted tip 124 and wrapped together and pulled through forward end. FIG. 35 shows such features, in detail, as assembled through tip 124. A mechanism or manual insertion tool (not shown)(separate from the machine) can be provided to advance the edge of the strip through tip 24 such that the strip is folded along both sides to form a single fold bias tape. Iron cover 164 of the heating assembly (corresponding to the mounted tip 124) is removed (before or after feeding into tip 124) and the leading edge of the folded tape is pulled across plate 74 and lower roller 68, as shown in FIGS. 19 and 33. Iron cover 164 is mounted and/or replaced and snapped into position on middle cover 14, so that the fabric extends through feed slot 196 and at least partially out of its dispensing slot. When powered (via pressing run button 88), the rollers 68 and 166 are rotated to advance the folded strip, cord, and fusible material, and heated assembly 160 presses folds along the sides of folded fabric received from tip 124 to heat the fusible material to fuse the edges and form the finished covered piping cord that is ejected. The spindle 20 rotates about its axis as the strip of material is advanced or pulled through the tip 124 and heated press assembly 160. Fusing material rotates about axis of spindle 132 as it is advanced therethrough. The device can fold and encase the piping cord as it passes through the tip 124. The pressed covered piping cord can pass between the heated assembly with a continuous feed at approximately 15 ft/min.

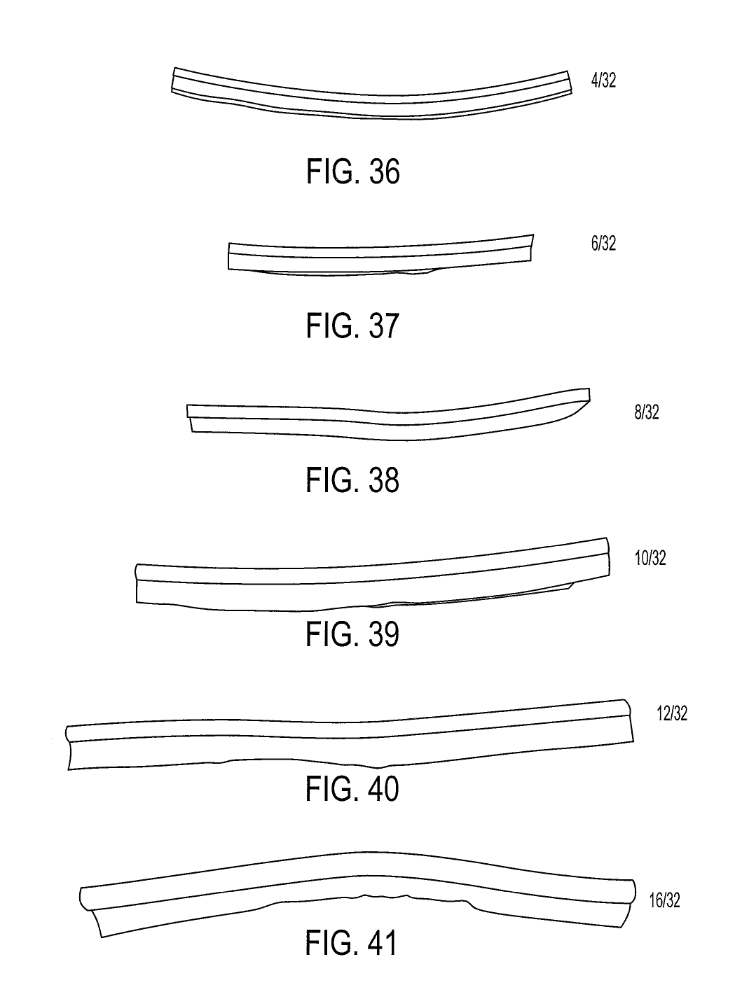

FIGS. 36-41 illustrate examples of different sizes covered piping cord that can be formed using device 10. For example, FIG. 36 shows 1⅜ inch wide fabric strip which covers a 4/32″ piping cord that was completed using the 4/32 inch tip 124A and iron cover 164A of FIGS. 20 and 26, respectively, with device 10. FIG. 37 shows 1⅝ inch wide fabric strip which covers a 6/32 inch piping cord that was completed using the 6/32 inch tip 124B and iron cover 164B of FIGS. 21 and 27, respectively. FIG. 38 shows 1¾ inch wide fabric strip which covers a 8/32 inch piping cord that was completed using the 8/32 inch tip 124C and iron cover 164C of FIGS. 22 and 28, respectively. FIG. 39 shows 2½ inch wide fabric strip which covers a 10/32 inch piping cord that was completed using the 10/32 inch tip 124D and iron cover 164D of FIGS. 23 and 29, respectively. FIG. 40 shows 2⅝ inch wide fabric strip which covers a 12/32 inch piping cord that was completed using the 12/32 inch tip 124E and iron cover 164E of FIGS. 24 and 30, respectively. FIG. 41 shows 3⅛ inch wide fabric strip which covers a 16/32 inch piping cord that was completed using the 16/32 inch tip 124F and iron cover 164F of FIGS. 25 and 31, respectively.

Accordingly, the combined bias tape and covered piping cord making device 10 as disclosed herein is configured to form both bias tape and covered piping cord. At least two folding tips—e.g., one bias tape tip 24 and one cord covering tip 124—are provided with the device and stored in the closed housing. Each tip 24, 124 is separately configured for mounting within the housing (within middle cover 14) and for communication with at least the spindle 20 for folding longitudinal edges of the strip of material. Depending on the project, one of the at least two folding tips 24 or 124 and at least part of the heated pressing assembly 60, 160 may be mounted within the housing in the open position, and the spindle, the mounted folding tip, and the heated pressing assembly are configured for operation. When a specific cord tip 124 is used, its corresponding upper cover 164 is mounted therein.

While the principles of the disclosure have been made clear in the illustrative embodiments set forth above, it will be apparent to those skilled in the art that various modifications and variations may be made to the structure, arrangement, proportion, elements, materials, and components used in the practice of the disclosure.

It will be realized that the foregoing preferred specific embodiments have been shown and described for the purpose of illustrating the functional and structural principles of this disclosure and are subject to change without departure from such principles. Therefore, this disclosure includes all modifications encompassed within the spirit and scope of the following claims.

1. A portable bias tape and covered piping cord making device, comprising:
a housing comprising a main housing and a cover hingedly connected to the main housing, the cover being configured to be positioned in an open position with respect to the main housing and in a closed position with respect to the main housing;
a first spindle rotatably disposed in the housing for supporting a strip of material;
a first folding tip configured to fold the strip of material about a piping cord forming a covered piping cord and adjacent folded longitudinal fabric strip, the first folding tip comprising a inner core and an outer shell with a substantially U-shaped fabric receiving space therebetween, the inner core having a piping cord channel for receiving the piping cord; and
a heated pressing assembly disposed in the housing for receiving and setting the adjacent longitudinal fabric strip,
wherein the spindle is mounted within one of the cover or the main housing, and one of the first folding tip and the heated pressing assembly are mounted within an other of the cover or the main housing, such that, with the housing in the open position, the spindle, the mounted folding tip, and the heated pressing assembly are configured for operation, and
wherein the cover is configured to enclose at least the spindle and at least a part of the heated pressing assembly within the housing in the closed position.

2. The device of claim 1, further comprising a guide arm removably located in the housing between the spindle and the mounted folding tip for guiding at least the strip of fabric into the mounted folding tip.

3. The device of claim 2, wherein the guide arm further guides piping cord and/or fusing material into the mounted folding tip.

4-8. (canceled)

9. The device of claim 1, wherein the heated pressing assembly includes an upper, spring loaded plate and a lower, heated stationary plate, and wherein the adjacent folded longitudinal fabric strip of the strip passes between the upper and lower plates to press the folds.

10. The device of claim 1, further comprising at least one roller located downstream of the heated pressing assembly to advance the strip of material from the spindle.

11. The device of claim 10, wherein the device comprises a pair of rollers that includes an upper roller located in an upper housing of the heated pressing assembly and a lower roller located in the main housing.

12. (canceled)

13. The device of claim 1, wherein the heated pressing assembly includes an upper, spring loaded plate and a lower, heated stationary plate, and wherein the adjacent folded longitudinal fabric strip of the strip passes between the upper and lower plates to press the folds; wherein the upper loaded plate and lower plate each have a planar surface and the heated pressing assembly includes an passageway adjacent the upper plate and lower plate for accommodating the covered piping, wherein the device is configured for the longitudinal fabric strip from the first folding tip to pass between the upper plate and lower plate and the covered piping to pass through the adjacent passageway.

14-17. (canceled)

18. The device of claim 1, wherein the mounted folding tape and heated pressing assembly are located in the main housing.

19. (canceled)

20. The device of claim 1, wherein the housing further comprises a latch to lock the cover and the main housing in the closed position.

21. (canceled)

22. The device of claim 21, further comprising a control unit with an automatic shut-off configured to shut off power to the heated pressing assembly after a predetermined period of time that device is not in use.

23. The device of claim 12, further comprising a control unit within the housing configured to selectively drive the lower roller to advance the folded strip of material through the mounted folding tip and heated pressing assembly.

24-27. (canceled)

28. The device of claim 1, further comprising a second spindle positioned in a horizontal direction and rotatable about a horizontal axis and configured to dispense the cord to the first folding tip.

29. The device of claim 29, wherein the first spindle is positioned vertically and rotatable about a vertical axis and configured to dispense a fusible material.

30. The device of claim 1, wherein the first folding tip further comprises a slot connected to the piping cord channel and configured to receive and guide the fusible material.

31. A portable bias tape and covered piping cord making device, comprising:
a housing comprising a main housing and a cover hingedly connected to the main housing, the cover being configured to be positioned in an open position with respect to the main housing and in a closed position with respect to the main housing;
a first spindle rotatably disposed about a vertical axis in the housing for supporting a strip of material;
a second spindle rotatably disposed about a horizontal axis in the housing for supporting a fusible material;
a first folding tip configured to fold the strip of material about a piping cord forming a covered piping cord and adjacent longitudinal fabric strip;
a heated pressing assembly disposed in the housing, the heated pressing assembly including an upper plate and a lower plate, wherein the heated pressing assembly includes a passageway adjacent the upper plate and lower plate for accommodating the covered piping, wherein the device is configured for the longitudinal fabric strip from the first folding tip to pass between the upper plate and lower plate to press the folds and the covered piping to pass through the adjacent passageway.

32. The device of claim 31, wherein the first folding tip comprising a inner core and an outer shell with a substantially U-shaped fabric receiving space therebetween, the inner core having a piping cord channel for receiving the piping cord;
